(19) United States
(12) Patent Application Publication
(10) Pub. No.: US 2006/0073254 A1
(43) Pub. Date: Apr. 6, 2006

(54) No-carb tabletop sweeteners substitute

(76) Inventors: Steve Catani, Athens, GA (US); Steve Clarke, North Brunswick, NJ (US); Shyhyuan Liao, West Windsor, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/957,940

(22) Filed: Oct. 4, 2004

(51) Int. Cl. A23L 1/236

(52) U.S. Cl. 426/548

(57) ABSTRACT

The invention describes no-carbohydrate tabletop sweetener compositions including a combination of a high intensity sweetener, such as sucralose and fillers such as amino acids and proteins. Amino acids combinations improve the taste quality of the sweetener substitute. The composition is suitable for use as tabletop sweeteners and ideal for low-carbohydrate diet purposes.

The invention relates to a tabletop sweetener substitute that does not contain dietary significant amounts of carbohydrates. The invention is suitable as a table sugar substitute for use on hot or cold coffee, hot or cold tea, hot or cold cereals, fruits, etc.

### BACKGROUND OF THE INVENTION

Intense sweetening agents are natural or synthetic compounds, which have a sweetening intensity greater than that of sugar (sucrose) and which oftentimes have a lower caloric value than that of sugar. Because the intense sweeteners provide greater sweetening capacity than sugar, smaller amounts of the sweeteners will provide sweetening intensity equivalent to larger amounts of sugar. Intense sweeteners are well known in the art and are widely used in place of sugar in many low calorie and/or noncariogenic compositions. Intense sweeteners can provide compositions that have decreased caloric value, as compared to sugar-sweetened compositions, because far lower amounts of the intense sweetener are required to achieve optimum sweetness in the composition.

High intensity sweeteners can provide the sweetness of sugar (although often with a slightly different taste), but since they are many times sweeter than sugar, only a small amount is needed to replace the sugar. For example, saccharin and aspartame, have 180 to 300 times the sweetness of an equivalent dose of sucrose (“sweetness equivalent”), while sucralose is a sweetener that is 600 times sweeter than sucrose. Therefore, in solid and semi-solid food applications, high intensity sweeteners are usually mixed with a bulking agent such as polydextrose. The intent is for the bulking agent to fulfill as many of sugar's roles as possible.

In order for intense sweeteners to have the same look, feel and consistency, the intense sweetener must be blended or admixed with bulking agents or similar carrier systems into so-called bulked sweetener compositions. Carriers are an important ingredient in bulked sweetener compositions as they “carrying” it out of a packet or other serving dispenser. Additionally, the carrier can act to effectively disperse the high intensity sweetener within or over a product. In the absence of a carrier, the high intensity sweetener may be concentrated in particular regions and produce non-uniformly tasting food products.

Various blends of intense sweeteners, sucrose and/or other sweetening agents have been explored for this application. A bulked sweetener composition is described as having the same sweetness as an equivalent volume of sucrose and prepared by spray drying a mixture that consisted of a maltodextrin solution (222.2 grams dry weight) and 4,1′-dichloro-4,1′-dideoxygalactosucrose (1.7 grams) or 1,1′,6′-trichloro-4,1′6′6-trideoxygalactosesucrose (0.5 grams). Published PCT patent application WO 89/03182 discloses synergistic sweetening compositions that comprise sucralose and a saccharide bulk-sweetening agent selected from the group consisting of fructose, glucose, maltose, xylitol, mannitol, and sorbitol.

Many and various bulking agents (carriers, diluents, extenders) are known. The particular bulking agent chosen for a specific composition must be sufficient in physical make-up to provide the specific bulk and texture required. Suitable carbohydrate bulking agents include sugars, sugar alcohols, hydrogenated hexoses, hydrogenated disaccharides, hydrogenated starch hydrolysates and mixtures thereof. Other suitable bulking agents include minerals such as calcium carbonate, talc, titanium dioxide, dicalcium phosphate, celluloses and the like.

Sugar bulking agents include monosaccharides, disaccharides and polysaccharides such as xylose, ribulose, glucose (dextrose), mannose, galactose, fructose (levulose), sucrose (sugar), maltose, invert sugar, partially hydrolyzed starch and corn syrup solids, and mixtures thereof. Sugar alcohol bulking agents include sorbitol, xylitol, mannitol, galactitol, maltitol, and mixtures thereof. Maltitol is disclosed in U.S. Pat. No. 3,708,396 as being a sweet, non-caloric, water-soluble sugar alcohol useful as a bulking agent in the preparation of non-caloric beverages and foodstuffs. Bulking agents generally have sweetness equivalents that are less than 1.

There is no prior art disclosing a tabletop sugar substitute that does not contain dietary significant amounts of carbohydrates. US2003/0035875 discloses a composition comprising a high intensity sweetener combined with a food additive comprising an amino acid. However, US2003/0035875 does not disclose sucralose as the chosen high-intensity sweetener and does not claim the invention lacks carbohydrates.

The present invention provides a solid, tabletop sugar substitute that does not contain dietary significant amounts of carbohydrates and is suitable for use in all applications in which tabletop sugar substitutes are used.

### SUMMARY OF THE INVENTION

A solid no carbohydrate sweetener composition comprising high intensity sweeteners, such as saccharin, stevioside, glycyrrhizin, thaumatin, aspartame, cyclamates, acesulfame-K, sucralose, alitame, or other suitable dipeptides and a filler wherein said filler is selected from the group consisting of amino acids, proteins, and a mixture thereof. The sweetener composition preferably has a sweetness equivalent number of at least 0.6, alternatively 0.8, or 1. Further, the sweetener composition preferably has a sweetness equivalent number of no more than 2, alternatively 1.5, or 1.2. Further, the sweetener composition is preferably in the form of a free-flowing powdery or granular mass. The term “powder” means a free flowing solid material having a mean particle size of 1 micron to ⅛ inch, comprised of amorphous or crystalline material, which may have been ground, screened, compressed, milled, agglomerated, coated, panned, or otherwise size or surface modified.

The amino acid can be chosen from the group consisting of glycine, alanine, threonine, proline, serine, lysine, phenylalanine, tryptophan, arginine, isoleucine, valine, leucine, methionine, glutamine, aspartate, histidine, and mixtures thereof. The protein can be a selected dietary protein product, such as those chosen from the group consisting of valileo, bovine serum albumin, lacta-albumin, lacto-globulin, hydrolyzed dairy, whey, or gelatin vegetable proteins. The composition comprises 80-99.9% by weight of filler material. The composition is in a powder form and is packed in less than or equal to about 1 g portions. The composition is used to sweeten food product by direct application. The composition can be promoted to subjects suffering from hyperglycemia or obesity. The composition is used as an improved tasting tabletop sugar substitute.

### DETAILED DESCRIPTION OF THE INVENTION

In one embodiment, the present invention is a no-carbohydrate tabletop sweetener composition comprising a high intensity sweetener and amino acids. A number of high intensity sweeteners are known and commercially available. Suitable high intensity sweeteners include: dipeptide based sweeteners such as L-aspartyl-L-phenylalanine methyl ester (Aspartame) and equivalents (described in U.S. Pat. No. 3,492,131), L-α-aspartyl-N-(2,2,4,4-tetramethyl-3-thietanyl)-D-alaninamide hydrate (Alitame) and the like; saccharin and its soluble salts eg sodium or calcium saccharin salts; chlorinated derivatives of sucrose such as chlorodeoxysucrose and the like; cyclamate salts for example acesulfame-K and the like; and protein based sweeteners, such as Thaumatin (talin). The high intensity sweetener employed in this invention can, for example, be sucralose, which is the compound 4,1′,6′-trichloro-4,1′,6′-trideoxygalactosucrose.

Sucralose and the methods of making sucralose and its derivatives have been described in numerous patents such as U.S. Pat. Nos. 4,801,700; 4,950,746; 5,470,969; and 5,498,709 which are hereby incorporated herein by reference.

The intense sweetening agents (sweeteners) in the present invention are preferably chlorodeoxysugar derivatives. The chlorodeoxysugar derivatives may be selected from the group consisting of chlorodeoxysucrose derivatives, chlorodeoxygalactosucrose derivatives, and mixtures thereof. Examples of chlorodeoxysucrose and chlorodeoxygalactosucrose derivatives include but are not limited to:

(a) 1-chloro-1′-deoxysucrose;

(b) 4-chloro-4-deoxy-alpha-D-galactopyranosyl-alpha-D-fructofuranoside, or 4-chloro-4-deoxygalactosucrose;

(c) 4-chloro-4-deoxy-alpha-D-galactopyranosyl-1-chloro-1-deoxy-beta-D-fructofuranoside, or 4,1′-dichloro-4,1′-dideoxygalactosucrose;

(d) 1′,6′-dichloro-1′,6′-dideoxysucrose;

(e) 4-chloro-4-deoxy-alpha-D-galactopyranosyl-6-dichloro-1,6-dideoxy-beta-D-fructofuranoside, or 4,1′,6′-trichloro-4,1′,6′-trideoxygalactosucrose;

(f) 4,6-dichloro-4,6-dideoxy-alpha-D-galacto-pyranosyl-6-chloro-6-deoxy-beta-D-fructofuranoside, or 4,6,6′-trichloro-4,6,6′-trideoxygalactosucrose;

(g) 6,1′,6′-trichloro-6,1′,6′-trideoxysucrose;

(h) 4,6-dichloro-4,6-dideoxy-alpha-D-galacto-pyranosyl-1,6-dichloro-1,6-dideoxy-beta-D-fructo-furanoside, or 4,6,1′,6′-tetrachloro-4,6,1′,6′-tetra-deoxygalactosucrose; and

(i) 4,6,1′,6′-tetrachloro-4,6,1′,6′-tetra-deoxysucrose.

In a preferred embodiment, the chlorodeoxysugar derivative is 4,1′,6′-trichloro-4,1′,6′-trideoxygalacto-sucrose (C₁₂ H₁₉ Cl₃ O₈, 4-chloro-4-deoxy-alpha-D-galacto-pyranosyl-1,6-dichloro-1,6-dideoxy-beta-D-fructo-furanoside) which is commercially available under the tradename Sucralose from Tate and Lyle Sucralose Inc, McIntosh, Ala. Sucralose is a free-flowing white crystalline solid that is freely soluble in water. Sucralose is prepared from sucrose in a multi-step process that selectively substitutes three chlorine atoms for three hydroxyl groups.

An amino acid is defined as the molecule containing an amino group (NH₂), a carboxyl group (COOH) and an R group. It has the following general formula,
R—CH(NH₂)—COOH

The R group differs among various amino acids. The amino acid employed in this invention can be any one of the following:

| | |
|---|---|
| Alanine (Ala) | 2-Aminopropanoic acid |
| Glutamine | 2-Amino-4-carbamoylbutanoic acid |
| (Gln) | |
| Glycine (Gly) | Aminoethanoic acid |
| Lysine (Lys) | 2,6-Diaminohexanoic acid |
| Proline (Pro) | Pyrrolidine-2-carboxylic acid |
| Serine (Ser) | 2-Amino-3-hydroxypropanoicacid |
| Threonine | 2-Amino-3-hydroxybutanoicacid |
| (Thr) | |
| Arginine | 2-Amino-5-guanidinopentanoic acid |
| (Arg) | |
| Isoleucine | 2-Amino-3-methylpentanoicacid |
| (Ile) | |
| Leucine (Leu) | 2-Amino-4-methylpentanoicacid |
| Methionine | 2-Amino-4-(methylthio)butanoicacid |
| (Met) | |
| Phenylalanine | 2-Amino-3-phenylpropanoicacid |
| (Phe) | |
| Tryptophan | 2-Amino-3-(lH-indol-3-yl)-propanoic acid |
| (Trp) | |
| Valine (Val) | 2-Amino-3-methylbutanoicacid |
| Tyrosine | 2-Amino-3-(4-hydroxyphenyl-propanoic acid |
| (Tyr) | |
| Asparagine | 2-Amino-3-carbamoylpropanoic acid |
| (Asn) | |
| Aspartic acid | 2-Aminobutanedioic acid |
| (Asp) | |
| Cysteine | 2-Amino-3-mercaptopropanoic acid |
| (Cys) | |
| Glutamic acid | 2-Aminopentanedioic acid |
| (Glu) | |
| Histidine | 2-Amino-3-(1H-imidazol-4-yl)-propanoic |
| (His) | acid |

Preferred amino acids are generally non-bitter amino acids, including glycine, alanine, threonine, proline, serine, lysine, phenylalanine, tryptophan, arginine, isoleucine, valine, leucine, methionine, glutamine, aspartate, and histidine.

In another embodiment, the present invention is a no-carbohydrate tabletop sweetener composition comprising sucralose and proteins. Proteins are molecules made up of a sequence of amino acids. The proteins employed in this invention can be any known dietary proteins and hydrolyzed or glycolyzed products thereof.

Non-limiting examples of useful plant derived proteins include: seed proteins that are isolated or derived from legumes, such as soybeans, peanuts, peas and beans; cereal proteins isolated or derived from cereal grains, such as wheat, oats, rice, corn, barley and rye; and mixtures thereof. Non-limiting examples of useful seed proteins include materials selected from the group consisting of soy flour, soy protein concentrate, soy protein isolate, peanut flour and mixtures thereof. Non-limiting examples of useful cereal proteins include materials selected from the group consisting of wheat flour, wheat protein concentrate and mixtures thereof.

Non-limiting examples of useful animal-derived proteins include, milk proteins that are isolated or derived from bovine milk; egg proteins isolated or derived from eggs or components of eggs; and mixtures thereof. Non-limiting examples of useful milk proteins include caseins, such as sodium caseinate and calcium caseinate; and whey proteins, such as beta-lactoglobulin and alpha-lactalbumin. These milk proteins may be derived from whole milk, skim milk, nonfat dry milk solids, whey, whey protein concentrate, whey protein isolate, caseinates, and mixtures thereof.

The preferred protein sources are valileo, bovine serum albumin, lacta-albumin, lacto-globulin, hydrolyzed dairy, whey, or gelatin vegetable proteins.

In a third embodiment, the present invention is a no-carbohydrate tabletop sweetener composition comprising sucralose and a mixture of one or more amino acids, one or more proteins, and mixtures thereof.

The amino acids and proteins are used as fillers for the sucralose. The claimed invention comprises 80-99.9% of the filler material. The remainder of the composition is sucralose.

In preparing the claimed invention, the sucralose/filler composition can be produced by dry mixing, co-spray drying, co-freeze drying, blending, co-drying, or by any other convenient process. The primary consideration is that the components be evenly distributed.

A method of producing such a sweetening material includes the steps of feeding to a spray drier a mixture comprising the filler and the sucralose, such mixture being in the liquid phase in the form of a water-based syrup and in the solid phase in the form of powder; contacting the syrup and powder as it passes through the spray drier whereby all or most of the powder particles will pick up some of the syrup and will become sticky, and will agglomerate together while drying and screening the spray dried material so as to separate any non-agglomerated powder, together with the agglomerates which are above and below a predetermined range of screen sixes, from the intermediate sized remainder; which constitutes the end product.

For commercial production such method is continuous, in which case the oversized and undersized agglomerates are pulverized after separation to reduce them to powder which, together with any non-agglomerated powder may be recycled through the spray drier and will then constitute all or part of the powder supply thereto.

The sucralose/filler composition is used as a tabletop sugar substitute. It can be used for all purposes that present tabletop sugar substitutes are used for, but unlike those sugar substitutes, the claimed invention does not have any carbohydrates. The phrase “no-carbohydrate” means that the composition is substantially free of carbohydrate bulking agents, which include sugars, sugar alcohols, hydrogenated hexoses, hydrogenated disaccharides, hydrogenated starch hydrolysates and mixtures thereof. Sugar bulking agents include monosaccharides, disaccharides and polysaccharides such as xylose, ribulose, glucose (dextrose), mannose, galactose, fructose (levulose), sucrose (sugar), maltose, invert sugar, partially hydrolyzed starch and corn syrup solids, and mixtures thereof. Sugar alcohol bulking agents include sorbitol, xylitol, mannitol, galactitol, maltitol, and mixtures thereof. Substantially free means that the carbohydrate content of the composition is less than 1.5 gram of carbohydrate per teaspoon serving, more preferably less than 1 gram of carbohydrate per teaspoon serving. Alternatively, the inventive compositions have less than 4 carbohydrate-based calories per gram of sucrose equivalent sweetness, further, less than 2 carbohydrate-based calories per gram of sucrose equivalent sweetness.

The claimed invention can be mixed with coffee or tea to provide a sweeter taste. Another possible use for the claimed invention is to sweeten cold or hot cereals by direct addition. Because the claimed invention does not contain dietary significant amounts of carbohydrates, usage of the claimed invention can be a useful means for weight management by reducing the subject's carbohydrate intake.

The following non-limiting examples are provided to further illustrate the present invention. Numerous other embodiments of the present invention are possible which are consistent with the invention disclosed herein.

### EXAMPLE 1

The following Example has been presented in order to further illustrate the invention and is not intended to limit the invention in any way.

A test sweetener system formulation included 48 grams L-Proline and 2 grams sucralose, which translates to 96% by weight L-Proline and 4% by weight sucralose. The test sweetener system was compared to a control system in four food systems. The control tabletop sugar substitute used was Splenda®.

Consumer test participants were asked to rate their liking for the foods and the sweetness level of the foods using a 1-5 scale anchored at either end with “not at all” and “extremely”. They were provided with the test food and a container holding a 0.5 g serving of the test and control sweetener systems. They were required to sprinkle the sweetener system onto the food and then stir the food prior to tasting and making the ratings.

The first test food was hot coffee. 5 grams of instant coffee (“Kenco” Really Rich) were weighed out into a 200 mL beaker. 200 mL of boiling water was added and stirred.

The second test food was hot tea. One tea bag was placed in a 500 mL beaker. 200 mL of boiling water was added to the beaker. The tea was allowed to stand for three minutes prior to the tea bag being removed.

The third test food was cold cereal. 30 grams of cornflakes were placed into a bowl. 125 mL of semi-skimmed milk was added after addition of sweetener to the cornflakes.

The fourth test food was hot cereal. A packet of Quaker Oats Simple was placed into a bowl. 180 mL of semi-skimmed milk was added and the mixture was heated in a microwave on high (650 W) for three minutes.

The mean rating results of the test are presented in the following table:

| | | | |
|---|---|---|---|
| | | | Proline/ |
| Splenda ® | Proline/Sucralose | Splenda ® | Sucralose |
| Liking | Liking | Sweetness | Sweetness |

| | | | | |
|---|---|---|---|---|
| Hot Tea | 3 | 4 | 3 | 4.5 |
| Hot Coffee | 3 | 3 | 2.5 | 4.5 |
| Cold Cereal | 3.5 | 4 | 3 | 4 |
| Hot Cereal | 4 | 4 | 3 | 4 |

The participants rated liking for all four food systems containing the test sweetener as being either equal to or greater than the control sweetener system. All foods containing the test sweetener system were rated as being sweeter than the control system. Comments from the consumers indicated that the test sweetener system delivered a longer lasting sweetness and dissolved as well as the control system.

### EXAMPLE 2

The following Example has been presented in order to further illustrate the invention and is not intended to limit the invention in any way.

The test sweetener system formulation include 48 grams of L-Leucine and 2 grams of sucralose, which translates to 96% by weight L-Leucine and 4% by weight sucralose. The test sweetener system was compared to a control system in four food systems. The control tabletop sugar substitute used was Splenda®. The test methodologies and test foods used in Example 1 were also employed for this Example. The mean rating results of the test are presented in the following table:

| | | | | Leucine/ |
|---|---|---|---|---|
| | Splenda ® | Leucine/Sucralose | Splenda ® | Sucralose |
| | Liking | Liking | Sweetness | Sweetness |
| Hot Tea | 3 | 3 | 3 | 3.5 |
| Hot Coffee | 3 | 2 | 2.5 | 4 |
| Cold Cereal | 3.5 | 4 | 3 | 4 |
| Hot Cereal | 4 | 2.5 | 3 | 2.5 |

The participants rated the test sweetener equal to or greater than the control for overall liking in the hot tea and the cornflakes. The participants also rated the test sweetener equal to or greater than the control for sweetness in the hot tea, hot coffee, and cold cereal.

What is claimed is:

1. A solid sweetener composition comprising a high intensity sweetener and filler wherein said filler is selected from the group consisting of amino acids, proteins, and mixtures thereof, wherein the composition is in the form of a powder or granular, free-flowing mass

2. The composition according to claim 1 wherein said composition has less than about 4 carbohydrate-based calories per gram of sucrose equivalent sweetness.

3. The composition according to claim 1, wherein said composition has less than 2 carbohydrate-based calories per gram of sucrose equivalent sweetness.

4. The composition of claim 1 wherein the high intensity sweetener is selected from the group consisting of a dipeptide-based sweetener, Alitame; saccharin and its soluble salts; chlorodeoxysugar derivatives; cyclamate salts; protein-based sweeteners and mixtures thereof.

5. The composition of claim 1 wherein said filler comprises at least one amino acid selected from the group consisting of glycine, alanine, threonine, proline, serine, lysine, phenylalanine, tryptophan, arginine, isoleucine, valine, leucine, methionine, glutamine, aspartate and histidine.

6. The composition of claim 1 wherein said composition comprises 80-99.9% by weight of amino acids.

7. The composition of claim 4 wherein said composition comprises 80-99.9% by weight of said amino acids.

8. The composition of claim 1 wherein said filler comprises at least one dietary protein.

9. The composition according to claim 8 wherein the dietary protein is selected from the group consisting of at least one protein selected from the group consisting of valileo, bovine serum albumin, lacta-albumin, lacto-globulin, dairy, whey, gelatin vegetable protein, hydrolyzed or glycolyzed products thereof and mixtures thereof.

10. The composition of claim 1 wherein the high intensity sweetener is a chlorodeoxysugar derivative.

11. The composition of claim 7 wherein said composition contains 80-99.9% by weight of said proteins.

12. The composition of claim 1 wherein said filler comprises a mixture of at least one amino acid and at least one protein, wherein said at least one amino acid is selected from the group consisting of proline, leucine and glycine and said at least one protein is selected from the group consisting of valileo, bovine serum albumin, lacto-globulin, hydrolyzed dairy, whey and gelatin vegetable protein.

13. The composition of claim 1 wherein the high intensity sweetener is sucralose.

14. The composition of claim 10 wherein said composition contains 80-99.9% by weight of a mixture of at least one amino acid and at least one protein.

15. The composition of claim 1 wherein said composition is in a powder form having a sucrose equivalent sweetness number greater than about 0.6.

16. The composition according to composition 15 having a sucrose equivalent sweetness number of less than about 2.

17. A composition according to claim 13 wherein the total measurable carbohydrates is less than about 1.5 grams per teaspoon serving.

18. A method of preparing a sweetener composition comprising
a) combining a high intensity sweetener with an amino acid or dietary protein to produce a powder or granular free-flowing mass having a sucrose equivalent sweetness number greater than about 0.6.

19. A method according to claim 18 wherein the high intensity sweetener is sucralose.

20. A method according to claim 20 wherein the sweetener composition has a sucrose sweetness equivalent number less than about 2.
